(19) United States
(12) Patent Application Publication
(10) Pub. No.: US 2022/0288434 A1
(43) Pub. Date: Sep. 15, 2022

(54) BUILDING EXTERIOR FIRE SUPPRESSION SYSTEM

(71) Applicant: John E. Olin, Palo Alto, CA (US)

(72) Inventor: John E. Olin, Palo Alto, CA (US)

(21) Appl. No.: 17/689,752

(22) Filed: Mar. 8, 2022

Related U.S. Application Data
(60) Provisional application No. 63/158,873, filed on Mar. 9, 2021.

(51) Int. Cl. A62C 35/68; A62C 5/00; A62C 37/10; A62C 99/00

(52) U.S. Cl. CPC A62C 35/68; A62C 5/008; A62C 37/10; A62C 99/0018; A62C 99/0072

(57) ABSTRACT

An example fire suppression apparatus includes a nozzle assembly configured to emit a spray of water through a spray nozzle projecting outward from a side wall of the nozzle assembly. The nozzle assembly includes a union fitting body, a first compression nut threadably engaged with a first end of the side wall, a second compression nut threadably engaged with an opposite, second end, and a longitudinal aperture extending from the first end to the second end. A spray nozzle rotatably connected to the side wall is formed with a transverse spray channel in fluid communication with the longitudinal aperture. An apparatus embodiment optionally includes many of the nozzle assembly connected in series to one another by intervening water distribution pipes to form a water distribution network.

### FIELD OF THE INVENTION

Embodiments are related to water sprinkler systems for fighting building fires.

### BACKGROUND

From 2005 to 2020, more than 89,000 structures were damaged or destroyed by wildfires in the United States. A wildfire can spread to dozens or even hundreds of square miles, damage thousands of buildings, threaten the safety of thousands of people, and strain firefighting capacity and other emergency resources. The number and intensity of wildfires has been increasing in recent years.

As a wildfire approaches a building, the building is subjected heat from different causes. Exterior surfaces of the building are exposed to radiant heat. Hot combustion gases may accumulate under building overhangs such as eaves, raised porches, balconies, bay windows, and other building structures elevated above the ground. Windblown embers and other burning material may be blown into contact with the building. Spraying water onto exterior surfaces may cool combustion gases from the wildfire, extinguish burning embers, and cool exterior surfaces sufficiently to prevent combustion of building materials. However, an approaching wildfire may move so quickly and release so much heat that it may be dangerous for a person to attempt to fight the fire with a garden hose, lawn sprinkler, shoveled dirt, or other means. Or, a fire may approach when no one is present, delaying or eliminating direct, on-scene intervention. Automatic and/or remotely-activated water sprinkler systems for fire suppression have therefore been installed on some buildings to prevent or reduce damage from external fire sources such as wildfires and fires in other nearby buildings.

Fire suppression systems may be configured to direct many streams or sprays of water against exterior surfaces of a building to reduce damage to the building from a nearby brush fire, forest fire, or fire in another structure. Some fire prevention and extinguishing system include a piping network including pipe segments perforated with many small water spray apertures. When the fire prevention and extinguishing system is activated, a spray or stream of water may be emitted from each water spray aperture toward the building being protected.

The diameter of each water spray aperture, the number of water spray apertures per unit length of perforated pipe, and the radial position of each water spray aperture on perforated pipe segments will preferably be selected to deliver an amount of water flow sufficient for preventing heat and/or combustion damage to building structures. However, the pressure drop of water flowing through a perforated pipe can be substantial, possibly leading to large variations in water flow rates through water outlet apertures at different locations on a building being protected. Providing sufficient water flow for fire suppression at all external locations on a building may require substantial experimentation and modification of the perforated pipe segments of the fire prevention system. Variations in water pressure at the supply inlet to a water sprinkler fire prevention system, as may occur for example during fires affecting many buildings simultaneously, may render a perforated-pipe water sprinkler system ineffective for suppressing fires at all locations on external building structures.

Other fire prevention and extinguishing systems direct water through spray nozzles configured to emit water through an aperture formed through an end wall of the nozzle. The spray nozzles may receive water through holes drilled in the outer wall of a water distribution pipe. Using distribution pipe with perforations in the side walls increases the complexity and cost of installation and may introduce variations in flow rates from nozzle to nozzle.

Yet other water sprinkler fire prevention and extinguishing systems place some sprinkler components outside exterior surfaces of the building, for example positioning a spray nozzle outside the fascia or soffit, but place other components inside building spaces or on an opposite side of fascia or soffit. Such systems require holes to be drilled through fascia, soffit, or other parts of the building to connect the components to one another or to make connections to a water supply. Drilling holes through parts of the roof, walls, fascia, or soffit increases the risk of water damage to the building, increases the cost and difficulty of building maintenance and repairs to the water sprinkler system, and may provide entries for vermin.

### SUMMARY

Example apparatus embodiments of a fire suppression system include a first water supply pipe configured to receive water from a water supply; a valve connected to the first water supply pipe; a second water supply pipe connected to the valve; and a water distribution network connected to the second water supply pipe. The water distribution network is preferably configured for positioning under an overhang on a building without entering an interior space of the building. The example water distribution network includes at least one, and optionally many, of a nozzle assembly connected in series to one another by intervening water distribution pipes connected at their ends to ends of the nozzle assemblies.

Each nozzle assembly includes a union fitting body having a body side wall surrounding a longitudinal aperture extending from a first end to a second end of the union fitting body, with the union fitting body having a center axis extending from the first end to the second end, and the body side wall formed with a threaded nozzle receiving aperture in fluid communication with the longitudinal aperture. The example nozzle assembly further includes a spray nozzle rotatably engaged with the nozzle receiving aperture and the spray nozzle extending radially outward from the union fitting body.

The example spray nozzle includes a threaded end engaged in the nozzle receiving aperture and a spray channel extending through an outer surface of the spray nozzle, with the spray channel formed with a first spray deflection surface and a second spray deflection surface. The example spray nozzle is formed with a nozzle aperture extending through the first spray deflection surface and the threaded end, the nozzle aperture having a nozzle aperture center axis extending through the threaded end and the first spray deflection surface, the nozzle aperture center axis perpendicular to the nozzle assembly body center axis, and the nozzle aperture in fluid communication with the longitudinal aperture. The example spray nozzle further includes a spray emission direction extending outward through the spray channel and the outer surface; a first compression nut threadably engaged with the first end; and a second compression nut threadably engaged with the second end.

The example water distribution network further includes a water distribution pipe having a first end and a second end opposite the first end, with the water distribution pipe first end connected to the nozzle assembly body first end; and a second of the nozzle assembly, with the first end of the second nozzle assembly connected to the second end of the water distribution pipe.

An example embodiment of a nozzle assembly includes a union fitting body having a body side wall extending from a first end to a second end of the union fitting body, with the body side wall surrounding a longitudinal aperture extending from the first end to the second end, with the longitudinal aperture having a center axis extending from the first end to the second end, and with a threaded nozzle receiving aperture formed in the body side wall.

The example nozzle assembly further includes a spray nozzle. The example spray nozzle includes a threaded end engaged in the nozzle receiving aperture; a cylindrical segment opposite the threaded end, with the cylindrical segment having an outer cylindrical surface; a spray channel extending through the cylindrical segment across a diameter of the outer cylindrical surface, and the spray channel formed with a first spray deflection surface and a second spray deflection surface. The example spray nozzle further includes a nozzle aperture extending through the first spray deflection surface and the threaded end, with the nozzle aperture having a nozzle aperture center axis extending through the threaded end and the first spray deflection surface, with the nozzle aperture center axis perpendicular to the longitudinal aperture center axis; and a spray emission direction extending outward through the spray channel and the cylindrical outer surface. The nozzle assembly further includes a first compression nut threadably engaged with the first end; and a second compression nut threadably engaged with the second end.

### BRIEF DESCRIPTION OF THE DRAWINGS

FIG. 1 is a schematic diagram showing an example apparatus embodiment of a water distribution network including many nozzle assemblies positioned for protecting a building from an external source of fire.

FIG. 2 is a schematic diagram showing an example apparatus embodiment spraying water under the eave and against an external wall of a building.

FIG. 3 is a schematic diagram showing an example apparatus embodiment spraying water under the soffit of a roof overhang and against an external wall of a building.

FIG. 4 is a side view of an example nozzle assembly in accord with the disclosed apparatus embodiments.

FIG. 5 is an end view of the example nozzle assembly of FIG. 4.

FIG. 6 is a cross-sectional view A-A of the example nozzle assembly of FIGS. 1-6. A location and viewing direction of section A-A is marked with a section line A-A in FIG. 5.

FIG. 7 is an end view of an example inner compression ferrule used in some nozzle assembly embodiments.

FIG. 8 is a cross-sectional view B-B of the example inner compression ferrule of FIG. 7. A location and viewing direction of section B-B is marked with a section line B-B in FIG. 7.

FIG. 9 is an end view of an example outer compression ferrule used in some nozzle assembly embodiments.

FIG. 10 is a cross-sectional view C-C of the example outer compression ferrule of FIG. 9. A location and viewing direction of section C-C is marked with a section line C-C in FIG. 9.

FIG. 11 is a side view of the example spray nozzle of FIGS. 1-6.

FIG. 12 is a view toward an outer end of the example spray nozzle of FIG. 11.

FIG. 13 is a view toward the outer end of the spray nozzle from the example nozzle assembly of the preceding figures.

FIG. 14 is an end view of an example nozzle assembly having two spray nozzles.

### DESCRIPTION

Embodiments of a fire suppression apparatus are configured for attachment to external surfaces of a building without nozzle assemblies and interconnecting water distribution pipes positioned in enclosed spaces in the building and/or passing through exterior building surfaces. An example fire suppression apparatus includes a nozzle assembly configured to spray water under the overhangs and against the exterior walls of a building that may be exposed to a fire burning outside the building. Some embodiments include many nozzle assemblies connected to one another by intervening water distribution pipes to form a water distribution network. When the fire suppression apparatus is activated, the water distribution network receives water from a water source such as a municipal water supply, a water well, or a water storage tank. Water flows through the water distribution network and out through a spray nozzle on each nozzle assembly, exiting through a side wall of each spray nozzle to form diverging water sprays directed at exterior building surfaces.

The fire suppression apparatus is effective for rapidly and thoroughly wetting the eaves, soffits, and exterior walls of a building with a substantial, continuous flow of water until the fire suppression system is deactivated or the water supply is interrupted. The flow rate of water out of each nozzle assembly is preferably large enough to wet sprayed surfaces with a film of flowing water and cool hot combustion gases that pass through the water spray from the nozzle assemblies. Adjacent nozzle assemblies in the water distribution network are preferably positioned with overlapping water sprays. The flow rate of water out of each nozzle assembly is further preferably high enough to prevent wind or heated gases rising from a nearby fire from blowing sprayed water away from building surfaces. Sprayed water may safely be directed against window glass, plaster, siding, and wood without breaking or cracking building materials. With sufficient water pressure and volume from a water source, overlapping water sprays from individual nozzle assemblies in the water distribution network are effective for preventing or delaying ignition of building surfaces by radiated heat, hot gases, and embers from a nearby fire, and are further effective for impeding building combustion initiated before apparatus activation.

The components of the water distribution network are configured for installation on exterior building surfaces, without forming apertures through exterior surfaces such as fascia and soffit. Preferably, no part of a nozzle assembly or water distribution pipe connecting one nozzle assembly to another passes through fascia material, soffit material, rafters, joists, exterior wall cladding, roof decking, shingles, cantilevered extensions, balconies, raised porches, bay window overhangs, or other external structures and surfaces of a building. It is further preferable that no part of a nozzle assembly or water distribution pipe connecting one nozzle assembly to another nozzle assembly passes though interior spaces in building walls, enclosed eaves, balcony floors, enclosed spaces under bay windows, and so on. Keeping all parts of the water distribution network external to building surfaces and outside enclosed spaces reduces the cost and complexity of installation, reduces repair and replacement costs for network components, reduces repair and maintenance costs for the building, and eliminates points of entry for water and vermin.

The parts of the water distribution network, including the water distribution pipes and the nozzle assemblies, provide an effective amount of water for fire suppression when connected to a water supply having pressure in a normal range for residential water systems. The normal range for a residential water system may be from about 30 psi (pounds per square inch) to about 80 psi. At pressures below about 20 psi, a supplemental source of water pressure, such as a water pump or elevated reservoir, may be coupled to the water distribution network to provide sufficient water pressure for effective fire suppression.

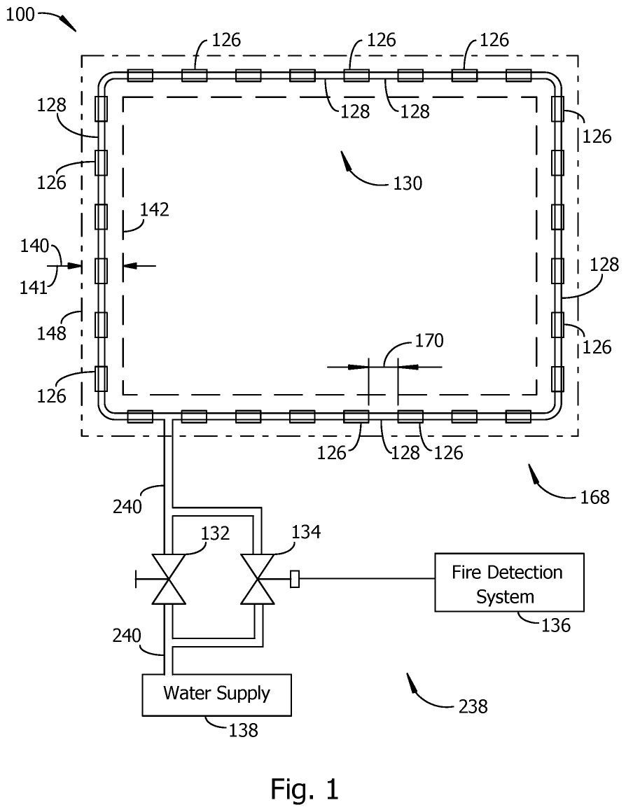

FIG. 1 shows in schematic form an example water distribution network 238 included with an embodiment 100 configured as a fire suppression system. An example building 168 is represented schematically by external walls 142 and an outer perimeter 148 of a roof. An overhang 141, for example an eave 140, extends outward from the external walls 142 to the outer perimeter 148. The example fire suppression system 100 is preferably positioned under the overhang 141 between the outer perimeter 148 and the external walls 142 so as to direct water spray upwards toward the underside of the overhang and onto the exterior walls.

In the example fire suppression system 100 of FIG. 1, many individual nozzle assemblies 126 are connected in series to one another by intervening water distribution pipes 128. Unlike some previously-known water sprinkler fire prevention systems, the side walls of the water distribution pipes 128 are preferably not perforated with apertures formed to be in fluid communication with a nozzle assembly. Instead, each nozzle assembly is connected end-to-end in series with a water distribution pipe, each nozzle assembly receiving water through an end of a water distribution pipe without water flowing through a side wall of the water distribution pipe. The direction of water spray from each nozzle assembly is independently adjustable from the directions of water sprays for other nozzle assemblies.

The number of nozzle assemblies 126 and a separation distance 170 between adjacent nozzle assemblies are preferably selected to rapidly wet the outer surfaces of the building side walls 142 and eaves 140 with overlapping, diverging water sprays and water flowing down the side walls from the water sprays. In an example embodiment, adjacent nozzle assemblies 126 are spaced apart from one another by a separation distance 170 in a range from about twelve inches (thirty centimeters) to about twenty-four inches (sixty-one centimeters). For a building with open eaves, i.e. no soffit covering the underside of the eaves, nozzle assemblies may be placed along the bottom of the fascia on the side toward the building walls, one nozzle between adjacent rafters, with spray nozzles arranged to direct water spray into the open spaces between rafters.

As suggested in the example of FIG. 1, the nozzle assemblies 126 and water distribution pipes 128 included in the water distribution network 238 optionally form a circulation loop 130 surrounding all exterior walls 142 to be protected from fire damage. The example circulation loop 130 may be more effective for providing uniform inlet pressure to each spray nozzle 102, and more uniform water outflow rates from all spray nozzles, than a branched water distribution network. The water distribution network 238 is coupled to a water supply 138 through water supply pipes 240 connected to an intervening manually-operated valve 132 and/or an electrically-operated valve 134. The electrically-operated valve opens and closes in response to electrical signals received from a fire detection system 136.

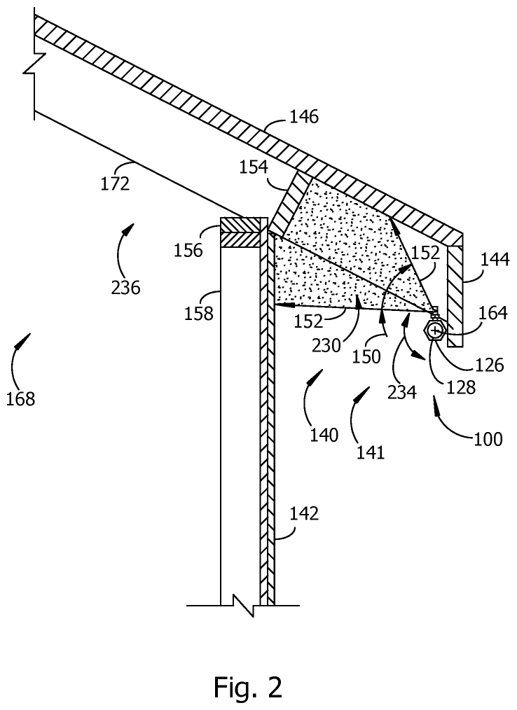

FIG. 2 illustrates an example of an embodiment 100 including one or more of the nozzle assemblies 126 and water distribution pipes 128 installed under an example overhang 141 between fascia 144 and the exterior wall 142 of an example building 168. The overhang 141 in FIG. 2 is an example of an eave 140, although installation under other kinds of structural overhang is possible as previously noted. As suggest in FIG. 2, the nozzle assembly 126 and water distribution pipe 128 are configured to be installed without any parts of these components passing through the fascia 144, roof decking 146, blocking 154, top plate 156, wall stud 158, rafter 172, or cladding on the exterior wall 142. Furthermore, the nozzle assembly 126 and water distribution pipe 128 may be installed without any parts of these components passing into or through enclosed interior spaces 236 of the example building 168.

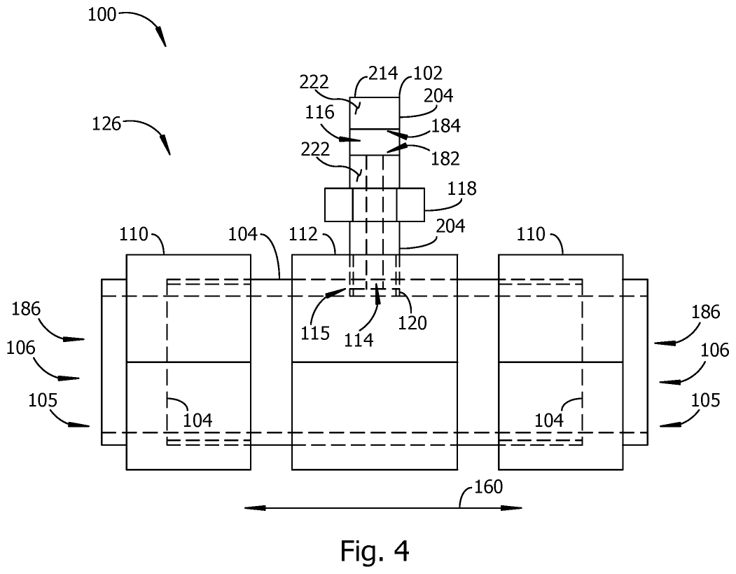

FIG. 2 further illustrates an example of diverging water spray 230 emitted from a nozzle assembly. Most of the water spray 230 will be emitted in a vertical dispersion angle 150 between the two example spray emission directions 152. The nozzle assembly 126 includes two independent rotational adjustments of the spray emission directions 152. A first rotational adjustment 234 of a spray emission direction 152 from the nozzle assembly 126 refers to rotation of the nozzle assembly 126 relative to the water distribution pipe 128 coupled to the nozzle assembly. Rotation of a nozzle assembly relative to a water distribution pipe is performed about a longitudinal center axis 164 through the union fitting body. The longitudinal center axis 164 is shown in more detail in FIGS. 4-6. The water distribution pipes will preferably be firmly secured to the fascia, rafters, soffit, or other strong exterior parts of the building, remaining stationary throughout the first rotational adjustment 234 of the nozzle assembly. In the example of FIG. 2, the longitudinal center axis 164 of the union fitting body arranged parallel to a bottom edge of the fascia. The first rotational adjustment 234 may be referred to as an elevation adjustment of the spray emission direction 152.

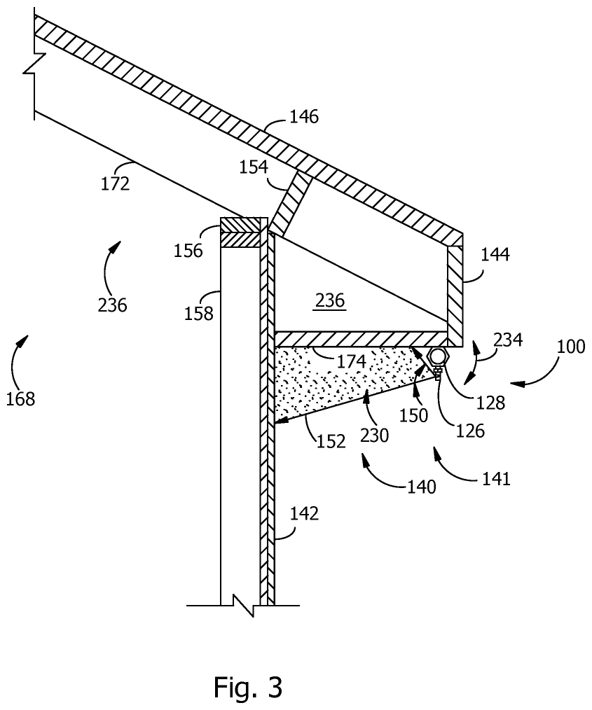

FIG. 3 shows an example embodiment 100 installed on a building overhang having a soffit 174 enclosing a bottom side of the overhang. As in FIG. 2, the nozzle assembly 126 and water distribution pipe 128 are installed under an example overhang 141 between fascia 144 and the exterior wall 142 of the example building 168, without passing through fascia surfaces, soffit surfaces, or wall surfaces. In the illustrated example, the nozzle assembly 126 and water distribution pipe are suspended from the soffit 174, although other attachments are possible. The nozzle assembly 126 is shown in an example position for directing water spray 230 onto external surfaces of the soffit and wall 142, without any part of the nozzle assembly and water distribution pipe passing into or through an enclosed space 236 in the example building 168.

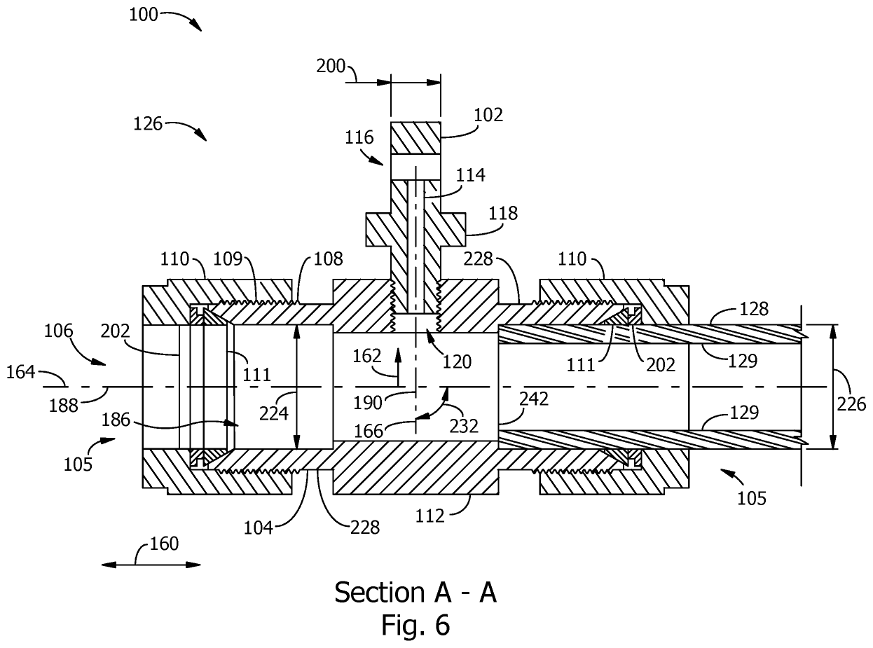

FIGS. 4-14 present examples of some features of a nozzle assembly 126 in accord with the disclosed apparatus embodiments 100. As shown in FIG. 4, an example nozzle assembly 126 includes a union fitting body 104, a spray nozzle 102 extending radially outward from the union fitting body, a first compression nut 110 threadably engaged with the union fitting body at a first end 105 of the nozzle assembly, and a second compression nut 110 threadably engaged with the union fitting body at a second end 105 opposite the first end. A through-hole 106 in each compression nut 110 and a longitudinal aperture 186 extending in a longitudinal direction 160 from the first end to the second end of the union fitting body are aligned with one another to accept an end 242 of a water distribution pipe (ref. FIG. 6).

The example spray nozzle 102 in FIG. 4 is formed with one or more cylindrical segments 204 and a spray channel 116 extending transversely across the longitudinal sides of the spray nozzle. The transverse spray channel 116 including a first spray deflection face 182 and a second spray deflection face 184 passes through the outer cylindrical surface 222 of the cylindrical segment 204 closest to the outer end 214 of the spray nozzle. An externally threaded end 115 of the spray nozzle 102 engages with an internally threaded nozzle receiving aperture 120 formed through an optional faceted circumferential flange 112 on the union fitting body 104. A nozzle aperture 114 extends from the threaded end 115 to the spray channel 116, passing through the first spray deflection surface 182 but not the second spray deflection surface 184. When the spray nozzle 102 is installed on the union fitting body 104, the nozzle aperture 114 is placed in fluid communication between the spray channel 116 and the longitudinal aperture 186 through the union fitting body, and the nozzle is rotatable about an axis passing through the nozzle aperture. A faceted circumferential flange 118 provides gripping surfaces for rotating the spray nozzle with a wrench.

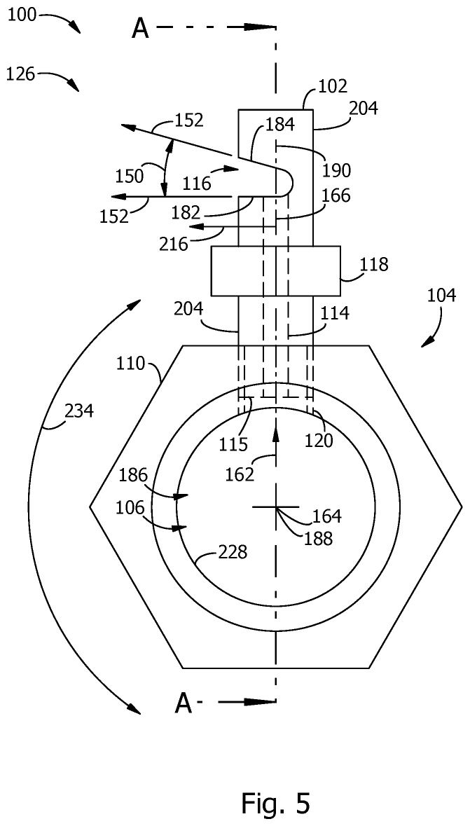

FIG. 5 shows an end view of the example nozzle assembly 126 of the preceding figures. The center axis 188 of the longitudinal aperture 186 is coincident with the longitudinal center axis 164 of the union fitting body 104. A spray nozzle center axis 166 at the center of the nozzle aperture 114 in the spray nozzle 102 extends in a radial direction 162 away from the union fitting body, where the radial direction 162 in the example of FIG. 5 is with respect to the longitudinal center axis 164 of the union fitting body. The nozzle receiving aperture 120 for the spray nozzle is formed through a side wall 228 of the union fitting body 104. When the nozzle assembly 126 is connected to a water distribution pipe inserted through the though-hole 106 in the compression nut 110, loosening the compression nuts 110 enables the first rotational adjustment 234 of the nozzle assembly about the center axis 188 while the water distribution pipe remains stationary. Tightening the compression nuts fixes the corresponding component of the spray emission direction 152.

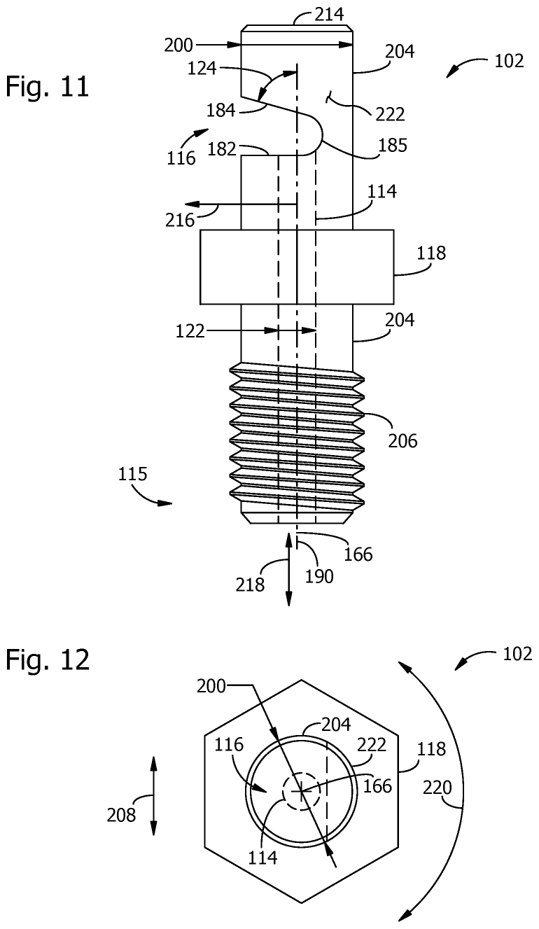

The spray emission directions 152 for the emitted water spray are further established by angles of the first and second spray deflection surfaces in the spray channel 116. In the example of FIG. 5, the first spray deflection surface 182 is perpendicular to the spray nozzle center axis 166 passing through the center of the nozzle aperture 114. The second spray deflection surface 184 is preferably not parallel to the first spray deflection surface, and may be formed with an acute angle 124 (ref. FIG. 11) greater than 60 degrees between the nozzle aperture center axis 190 and the second spray deflection surface. The first spray deflection surface 182 and the second spray deflection surface 184 both extend away from the nozzle aperture 114 in a radial direction 216 with respect to the center axis 166 of the spray nozzle 102. The spray deflection surfaces of the spray channel contribute to the vertical dispersion angle 150 of a water spray emitted from the spray channel. The spray deflection surfaces are preferably formed to create a diverging water spray with a vertical dispersion angle of at least 20 degrees.

Cross-sectional view A-A in FIG. 6 shows some additional details of the nozzle assembly 126. Internal threads 109 on the compression nuts 110 engage corresponding external threads 108 on the union fitting body 104. The example union fitting body is configured to accept two water distribution pipes, one at each end of the union fitting body. An example of a water distribution pipe 128 coupled to the union fitting body is shown at the right side of FIG. 6. Along part of its length, an inner diameter 224 of the longitudinal aperture 186 through the union fitting body is slightly greater than an outer diameter 226 of a water distribution pipe 128. The longitudinal aperture 186 preferably accepts the water distribution pipe with a sliding fit. A reduction in the inner diameter 224 may be provided to establish a preferred insertion distance into the longitudinal aperture 186 of an end 242 of the water distribution pipe 128. An inner ferrule 111 and an optional outer ferrule 202 placed around the outside of the water distribution pipe are firmly tightened against the exterior surface of the pipe to form a water-tight seal between the water distribution pipe and the union fitting body 104. No penetrations of the wall 129 of the water distribution pipe 128 are needed to establish water delivery to the spray nozzle 102. In some embodiments, the first ferrule 111 and the second ferrule 202 are formed as a single integrated part. The outer diameter 226 of a water distribution pipe may optionally be substantially larger than an outer diameter 200 of a spray nozzle 102. In the example of FIG. 6, the outer diameter of the water distribution pipe 128 is about three times the diameter of the spray nozzle and more than five times the diameter 122 of the nozzle aperture 114, although other relative diameters are possible.

FIG. 6 further shows an example of the spray channel 116 in fluid communication with the longitudinal aperture 186 in the union fitting body through the intervening nozzle aperture 114 and the nozzle receiving aperture 120 formed in the side wall 228 of the union fitting body. The nozzle aperture center axis 190, which in the illustrated example is coincident with the spray nozzle center axis 166, extends in a radial direction 162 away from the center axis 164 of the union fitting body. In the illustrated example, the nozzle aperture center axis 190 and the spray nozzle center axis 166 are at a perpendicular angle 232 to the longitudinal center axis 164 of the union fitting body.

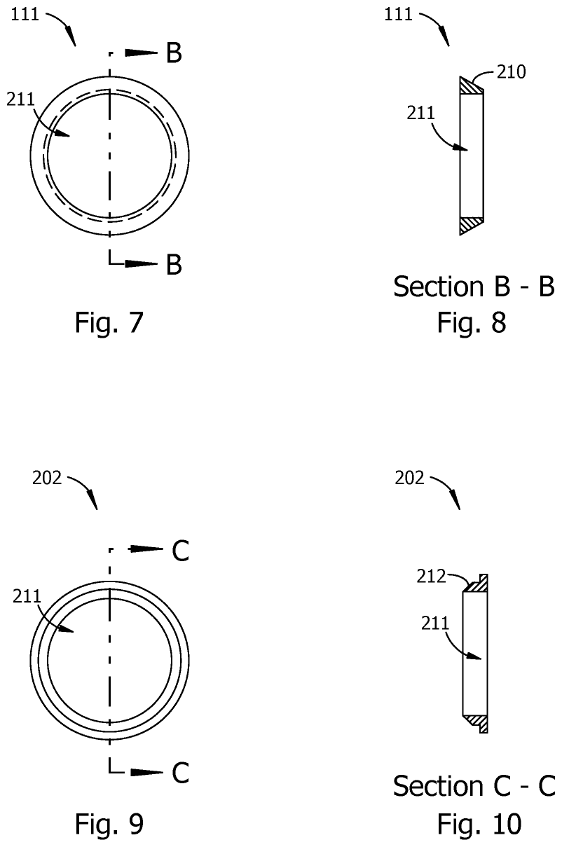

FIGS. 7-10 show examples of the inner ferrule 111 and the optional outer ferrule 202. A central aperture 211 in each of the inner and outer ferrules is sized for a close fit over the outer diameter 226 of a water distribution pipe 128. The example inner ferrule 111 is formed with an angled or rounded face 210. The example outer ferrule 202 is formed with an angled or rounded face 212. The angled or rounded faces slidably engage corresponding faces inside the compression nuts and at the opposite longitudinal ends of the union fitting body. Tightening the compression nuts compresses the ferrules to form watertight seals against the exterior surface of the side wall of the water distribution pipe.

FIG. 11 and FIG. 12 show some details of an example spray nozzle 102. In some embodiments, external threads 206 are configured to engage corresponding internal threads in the nozzle receiving aperture 120, preferably enabling rotational adjustment of the spray nozzle relative to the union fitting body and establishing a watertight connection between the spray nozzle and the union fitting body. The direction of the longest axis 218 of the spray nozzle is perpendicular to the diameter 200 of a cylindrical segment 204. The nozzle aperture 114 extends through the threaded end 115 and through the first spray deflection surface 182 but not the second spray deflection surface 184 of the transverse spray channel 116. The spray deflection surfaces extend to an arcuate back surface 185. The first spray deflection surface 182, second spray deflection surface 184, and back surface 185 form the sides of the spray channel 116. The spray channel 116 passes through the outer cylindrical surface 222 of a cylindrical segment 204 of the spray nozzle. The threaded engagement between the spray nozzle and the union fitting body provides a second rotational adjustment 220 of the spray emitting direction 152 independently of and at right angles to the first rotation adjustment 234. The second rotational adjustment may be referred to as an azimuth adjustment to distinguish it from the first rotational adjustment 234, which may be referred to as an elevation adjustment. FIG. 11 and FIG. 12 further show that the spray channel 116 extends in a transverse direction 208 across the diameter 200 of the spray nozzle and through the outer cylindrical surface 222.

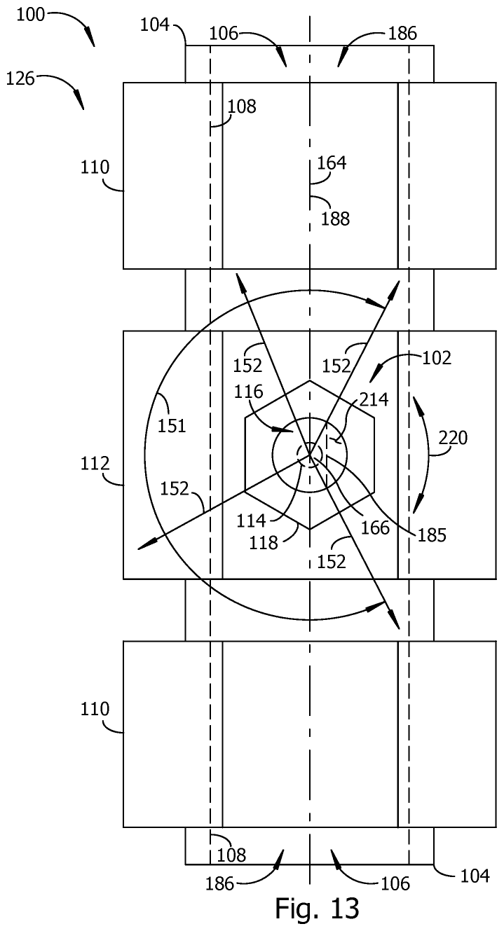

An example of a horizontal dispersion angle 151 for water spray emitted from the spray nozzle is shown in the view of FIG. 13 toward the outer end 214 of the spray nozzle 102. Water passing through the nozzle aperture 114 strikes the first spray deflection surface 182, the second spray deflection surface 184, and the back surface 185 to form a diverging water spray that spreads at the vertical dispersion angle 150, examples of which appear in FIG. 2, FIG. 3, and FIG. 5, and also at a horizontal dispersion angle 151 as in the example of FIG. 13.

Nozzle assemblies 126 at different locations in a fire suppression system 100 optionally include spray nozzles 102 formed with different values of the angle 124 of the second spray deflection surface 184 and/or a diameter 122 of the nozzle aperture 114 to provide different water outflow rates and directions from each of the nozzle assemblies 126. Nozzle assemblies 126 at different locations in a fire protection system 100 may optionally be provided with spray nozzles 102 having different values of the angle 124 of the second spray deflection surface 184 and/or diameter 122 of the nozzle aperture 114 to provide effective water flow rates and/or spray emission directions 152 at all locations in the water distribution network 238.

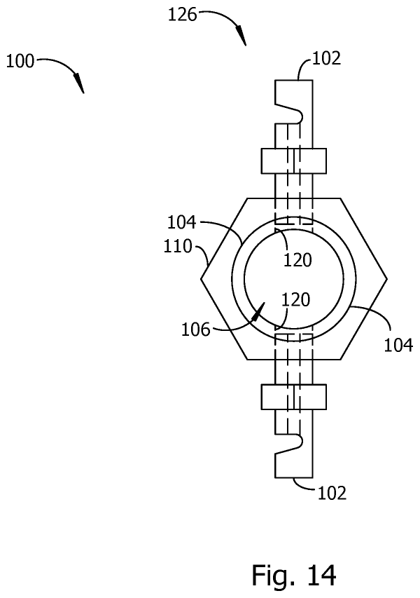

The example nozzle assembly 126 of the preceding figures includes one spray nozzle 102. As suggested in the example of FIG. 14, a nozzle assembly 126 may optionally be provided with more than one spray nozzle 102, enabling the nozzle assembly to output more than one water output spray, for example with a first spray nozzle directing a water output spray at objects above the nozzle assembly and a second spray nozzle directing a water output spray at objects below the nozzle assembly.

Unless expressly stated otherwise herein, ordinary terms have their corresponding ordinary meanings within the respective contexts of their presentations, and ordinary terms of art have their corresponding regular meanings.

What is claimed is:

1. A nozzle assembly for a fire suppression apparatus, comprising:
a union fitting body having a first end, a second end opposite said first end, a first compression nut threadably engaged with said first end, a second compression nut threadably engaged with said second end, and a body side wall surrounding a longitudinal aperture extending from said first end to said second end; and
a spray nozzle rotatably engaged with said body side wall, said spray nozzle formed with a transverse spray channel in fluid communication with said longitudinal aperture through an intervening nozzle aperture in said spray nozzle.

2. A nozzle assembly for a fire suppression apparatus, comprising:
a union fitting body comprising a body side wall extending from a first end to a second end of said union fitting body, said body side wall surrounding a longitudinal aperture extending from said first end to said second end, said longitudinal aperture having a center axis extending from said first end to said second end, and a threaded nozzle receiving aperture formed in said body side wall;
a spray nozzle, comprising:
a threaded end engaged in said nozzle receiving aperture;
a cylindrical segment opposite said threaded end, said cylindrical segment having an outer cylindrical surface, a spray channel extending through said cylindrical segment across a diameter of said outer cylindrical surface, and said spray channel formed with a first spray deflection surface and a second spray deflection surface;
a nozzle aperture extending through said first spray deflection surface and said threaded end, said nozzle aperture having a nozzle aperture center axis extending through said threaded end and said first spray deflection surface, said nozzle aperture center axis perpendicular to said longitudinal aperture center axis; and
a spray emission direction extending outward through said spray channel and said outer cylindrical surface;
a first compression nut threadably engaged with said first end; and
a second compression nut threadably engaged with said second end.

3. The apparatus of claim 2, further comprising a first ferrule interposed between said first compression nut and said first end.

4. The apparatus of claim 3, further comprising a second ferrule interposed between said first compression nut and said first ferrule.

5. The apparatus of claim 4, wherein said first ferrule and said second ferrule are integrally formed with one another.

6. The apparatus of claim 2, wherein a rotational engagement of said spray nozzle with said union fitting body provides a rotational adjustment of said spray emission direction.

7. The apparatus of claim 2, wherein said nozzle assembly is configured for receiving water from a water distribution pipe formed without an aperture through a sidewall of the water distribution pipe.

8. The apparatus of claim 2, wherein said nozzle aperture does not extend through said second spray deflection surface.

9. The apparatus of claim 2, wherein a water spray formed by said spray channel has a horizontal dispersion angle greater than 180 degrees.

10. The apparatus of claim 2, wherein a water spray formed by said spray channel has a vertical dispersion angle greater than 20 degrees.

11. The apparatus of claim 2, wherein an acute angle between said second spray deflection surface and said nozzle aperture center axis is greater than 60 degrees.

12. The apparatus of claim 2, wherein said first spray deflection surface is perpendicular to said nozzle aperture center axis.

13. The apparatus of claim 2, wherein said first spray deflection surface and said second spray deflection surface are not parallel to one another.

14. An apparatus for protecting a building from an external source of fire, comprising:
a first water supply pipe configured to receive water from a water supply;
a valve connected to said first water supply pipe;
a second water supply pipe connected to said valve;
a water distribution network connected to said second water supply pipe, said water distribution network configured for positioning under an overhang on a building without entering an interior space of the building, said water distribution network comprising:
a nozzle assembly, comprising:
a union fitting body comprising a body side wall surrounding a longitudinal aperture extending from a first end to a second end of said union fitting body, said nozzle assembly body having a center axis extending from said first end to said second end, and said body side wall formed with a threaded nozzle receiving aperture in fluid communication with said longitudinal aperture;
a spray nozzle extending radially outward from said union fitting body, comprising:
a threaded end engaged in said nozzle receiving aperture;
a spray channel extending through an outer surface of said spray nozzle, said spray channel formed with a first spray deflection surface and a second spray deflection surface;
a nozzle aperture extending through said first spray deflection surface and said threaded end, said nozzle aperture having a nozzle aperture center axis extending through said threaded end and said first spray deflection surface, said nozzle aperture center axis perpendicular to said nozzle assembly body center axis, and said nozzle aperture in fluid communication with said longitudinal aperture; and
a spray emission direction extending outward through said spray channel and said outer surface;
a first compression nut threadably engaged with said first end; and
a second compression nut threadably engaged with said second end;
a water distribution pipe having a first end and a second end opposite said first end, said water distribution pipe first end connected to said nozzle assembly body first end; and
a second of said nozzle assembly, said first end of said second nozzle assembly connected to said second end of said water distribution pipe.

15. The apparatus of claim 14, said water distribution network further comprising an additional plurality of said nozzle assembly and an additional plurality of said water distribution pipe, each of said nozzle assembly connected to another of said nozzle assembly by an intervening water distribution pipe.

16. The apparatus of claim 14, wherein no part of said nozzle assembly passes through a fascia of the building.

17. The apparatus of claim 14, wherein said water distribution pipe does not pass into an interior space of the building.

18. The apparatus of claim 14, wherein at least one of said nozzle assembly is positioned to spray upwards onto a soffit and onto an adjoining building wall.

19. The apparatus of claim 14, wherein at least one of said nozzle assembly is positioned to spray upwards under an overhang and onto an adjoining building wall.
